(19) United States
(12) Patent Application Publication
(10) Pub. No.: US 2024/0176724 A1
(43) Pub. Date: May 30, 2024

(54) COMPUTER-IMPLEMENTED METHOD AND COMPUTING SYSTEM FOR SOFTWARE EXECUTION AUTOMATION MONITORING

(71) Applicant: KEYSOFTS, JACOU (FR)

(72) Inventor: Sebastien MASSAT, JACOU (FR)

(21) Appl. No.: 18/059,659

(22) Filed: Nov. 29, 2022

(51) Int. Cl. G06F 11/36

(52) U.S. Cl. CPC G06F 11/3612; G06F 11/3664

(57) ABSTRACT

The computer-implemented method (100) for software execution automation monitoring, comprises:
a step (105) of defining, upon a computer interface, at least two software modules, each software module being associated with:
   a software digital identifier representative of an existing software to be executed or of an application interface to be addressed,
   an execution error code output format, and
   an execution error code output connector,
a step (110) of defining, upon a computer interface, a sequence of execution,
a step (115) of executing, by a software execution orchestrator ran upon computing device, of the sequence of execution,
a step (120) of receiving, by the software execution orchestrator, an error code, and
a step (125) of providing, upon a computer interface, an output representative of the received error code and of the software digital identifier associated with the error code.

### TECHNICAL FIELD OF THE INVENTION

The present invention relates to a computer-implemented a computer-implemented method for software execution automation monitoring and to a computing system for monitoring a software execution automation. It applies, in particular, to the field of process automation assisted by software.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Code implementation approaches for data exchange (automated interface technologies or APIs), as well as approaches for automating IT tasks (scheduler or RPA), do not link dependencies or identify the impacts of automation for users of business processes. Nor do they provide a global view (of all the automated processes in the company) and a centralized view (gathered in a single location).

Conversely, approaches based on code execution that follow the execution of business processes (Business Activity Monitoring) do not rely on exchanges of data that are important to the company in order to monitor the automation of interfaces.

In the field of information technology, business process automation through the use of software is at the forefront of productivity gains across all industries. However, within organizations, the number of software and complexity of interactions between said software, both internally and externally with third-party websites or applications, is increasing to a point where processes fail, and dissatisfaction grows among users.

Currently, the only way to monitor varied business automation software is to individually monitor each software.

### SUMMARY OF THE INVENTION

The present invention aims at overcoming the above-mentioned drawbacks as well as other drawbacks that could be overcome although not mentioned in the description below.

The concept of the present invention relates to the use of a one-stop shop coordinator (or orchestrator) software, which is connected to process automation software and other resources in such a way that it is able to link dependencies, identify impacts and follow the flow of data in a business process involving several automation software or interfaces.

Such an invention allows for faster detection of errors and improved maintenance of automation software.

Such an invention may take the form of a cloud solution (installed on a customer's server) providing true governance of digital exchanges, securing digital initiatives and providing users with at least part of the following detailed benefits:
simple and clear view of digital activities and exchanges (technical data becomes understandable by the business actors),
single measurement of the performance of all applications through a dashboard and a dynamic mapping of process execution,
application automation with automatic execution of digitized tasks,
prioritization of data flows for better application responsiveness,
easy coordination of application processes,
planning of business operations on the same tool,
process monitoring in a unified environment (for better reliability of operations),
real-time monitoring and control of process execution,
management of the successes and failures of process execution,
reduced time to detect an incident and analyze the cause of the malfunction,
better cooperation between the stakeholders (thanks to a shared vision between the IT departments and the other business units) through a single, collaborative interface,
a solution adapted to any application interface, the invention can, for example, use natively connectors made available by Microsoft to connect to API applications,
an organizational vision of the information exchanges between the internal or external actors of an organization,
operational research of a subject for a given process in order to ensure a traceability of it and of the GDPR (for “General Data Protection Regulation”) data exchanged in a predefined context and
financial impact evaluation of a data exchange in error by Business Unit and business domain with the number of employees of the impacted department.

Furthermore, the system is able to monitor different several parallel or sequential executions of sequences of software elements of different types and nature.

### BRIEF DESCRIPTION OF THE DRAWINGS

Other advantages, purposes and particular characteristics of the invention shall be apparent from the following non-exhaustive description of at least one particular method or system object of this invention, in relation to the drawings annexed hereto, in which:

FIG. 1 represents, schematically and in the form of a flowchart, a particular succession of steps of method object of the present invention,

FIG. 2 represents, schematically, a particular embodiment of a system object of the present invention, and

FIG. 3 represents, schematically, a sequence of execution of a sequence of software modules.

### DETAILED DESCRIPTION OF THE INVENTION

This description is not exhaustive, as each feature of one embodiment may be combined with any other feature of any other embodiment in an advantageous manner.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should be noted that the figures are not to scale.

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

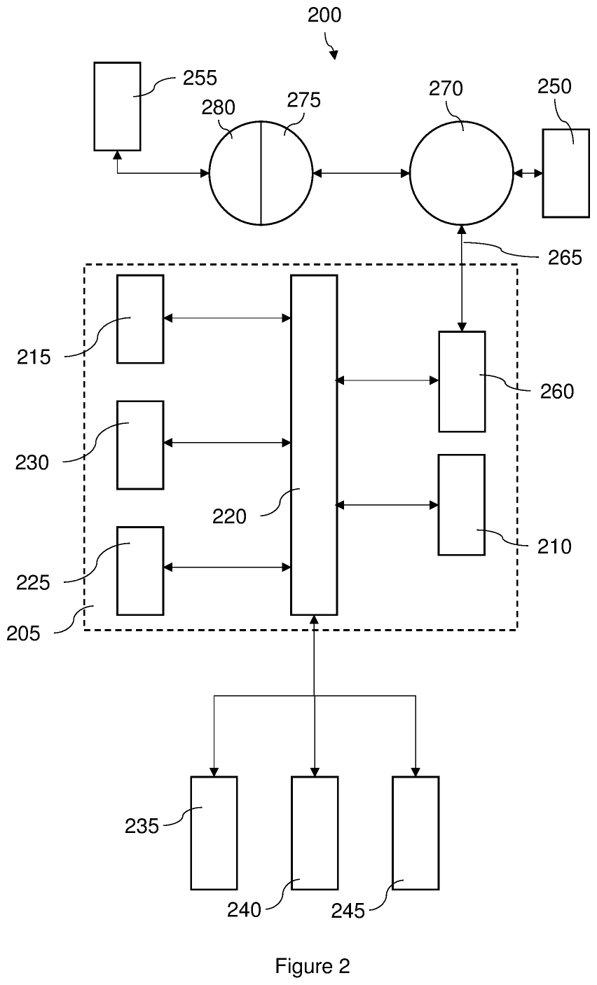

FIG. 2 represents a block diagram that illustrates an example computer system with which an embodiment may be implemented. In the example of FIG. 2, a computer system 205 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

The computer system 205 includes an input/output (IO) subsystem 220 which may include a bus and/or other communication mechanism(s) for communicating information and/or instructions between the components of the computer system 205 over electronic signal paths. The I/O subsystem 220 may include an I/O controller, a memory controller and at least one I/O port. The electronic signal paths are represented schematically in the drawings, for example as lines, unidirectional arrows, or bidirectional arrows.

At least one hardware processor 210 is coupled to the I/O subsystem 220 for processing information and instructions. Hardware processor 210 may include, for example, a general-purpose microprocessor or microcontroller and/or a special-purpose microprocessor such as an embedded system or a graphics processing unit (GPU) or a digital signal processor or ARM processor. Processor 210 may comprise an integrated arithmetic logic unit (ALU) or may be coupled to a separate ALU.

Computer system 205 includes one or more units of memory 225, such as a main memory, which is coupled to I/O subsystem 220 for electronically digitally storing data and instructions to be executed by processor 210. Memory 225 may include volatile memory such as various forms of random-access memory (RAM) or other dynamic storage device. Memory 225 also may be used for storing temporary variables or other intermediate information during execution of instructions to be executed by processor 210. Such instructions, when stored in non-transitory computer-readable storage media accessible to processor 210, can render computer system 205 into a special-purpose machine that is customized to perform the operations specified in the instructions.

Computer system 205 further includes non-volatile memory such as read only memory (ROM) 230 or other static storage device coupled to the I/O subsystem 220 for storing information and instructions for processor 210. The ROM 230 may include various forms of programmable ROM (PROM) such as erasable PROM (EPROM) or electrically erasable PROM (EEPROM). A unit of persistent storage 215 may include various forms of non-volatile RAM (NVRAM), such as FLASH memory, or solid-state storage, magnetic disk, or optical disk such as CD-ROM or DVD-ROM and may be coupled to I/O subsystem 220 for storing information and instructions. Storage 215 is an example of a non-transitory computer-readable medium that may be used to store instructions and data which when executed by the processor 210 cause performing computer-implemented methods to execute the techniques herein.

The instructions in memory 225, ROM 230 or storage 215 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 205 may be coupled via I/O subsystem 220 to at least one output device 235. In one embodiment, output device 235 is a digital computer display. Examples of a display that may be used in various embodiments include a touch screen display or a light-emitting diode (LED) display or a liquid crystal display (LCD) or an e-paper display. Computer system 205 may include other type(s) of output devices 235, alternatively or in addition to a display device. Examples of other output devices 235 include printers, ticket printers, plotters, projectors, sound cards or video cards, speakers, buzzers or piezoelectric devices or other audible devices, lamps or LED or LCD indicators, haptic devices, actuators, or servos.

At least one input device 240 is coupled to I/O subsystem 220 for communicating signals, data, command selections or gestures to processor 210. Examples of input devices 240 include touch screens, microphones, still and video digital cameras, alphanumeric and other keys, keypads, keyboards, graphics tablets, image scanners, joysticks, clocks, switches, buttons, dials, slides.

Another type of input device is a control device 245, which may perform cursor control or other automated control functions such as navigation in a graphical interface on a display screen, alternatively or in addition to input functions. Control device 245 may be a touchpad, a mouse, a trackball, or cursor direction keys for communicating direction information and command selections to processor 210 and for controlling cursor movement on display 235. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 240 may include a combination of multiple different input devices, such as a video camera and a depth sensor.

In another embodiment, computer system 205 may comprise an internet of things (IoT) device in which one or more of the output device 235, input device 240, and control device 245 are omitted. Or, in such an embodiment, the input device 240 may comprise one or more cameras, motion detectors, thermometers, microphones, seismic detectors, other sensors or detectors, measurement devices or encoders and the output device 235 may comprise a special-purpose display such as a single-line LED or LCD display, one or more indicators, a display panel, a meter, a valve, a solenoid, an actuator or a servo.

Computer system 205 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 205 in response to processor 210 executing at least one sequence of at least one instruction contained in main memory 225. Such instructions may be read into main memory 225 from another storage medium, such as storage 215. Execution of the sequences of instructions contained in main memory 225 causes processor 210 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 215. Volatile media includes dynamic memory, such as memory 225. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 220. Transmission media can also take the form of acoustic or light waves, such as those generated during radio-wave and infra-red data communications.

Various forms of media may be involved in carrying at least one sequence of at least one instruction to processor 210 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 205 can receive the data on the communication link and convert the data to a format that can be read by computer system 205. For instance, a receiver such as a radio frequency antenna or an infrared detector can receive the data carried in a wireless or optical signal and appropriate circuitry can provide the data to I/O subsystem 220 such as place the data on a bus. I/O subsystem 220 carries the data to memory 225, from which processor 210 retrieves and executes the instructions. The instructions received by memory 225 may optionally be stored on storage 215 either before or after execution by processor 210.

Computer system 205 also includes a communication interface 260 coupled to bus 220. Communication interface 260 provides a two-way data communication coupling to network link(s) 265 that are directly or indirectly connected to at least one communication networks, such as a network 270 or a public or private cloud on the Internet. For example, communication interface 260 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 270 broadly represents a local area network (LAN), wide-area network (WAN), campus network, internetwork, or any combination thereof. Communication interface 260 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 260 sends and receives electrical, electromagnetic, or optical signals over signal paths that carry digital data streams representing various types of information.

Network link 265 typically provides electrical, electromagnetic, or optical data communication directly or through at least one network to other data devices, using, for example, satellite, cellular, Wi-Fi, or BLUETOOTH technology. For example, network link 265 may provide a connection through a network 270 to a host computer 250.

Furthermore, network link 265 may provide a connection through network 270 or to other computing devices via internetworking devices and/or computers that are operated by an Internet Service Provider (ISP) 275. ISP 275 provides data communication services through a world-wide packet data communication network represented as internet 280. A server computer 255 may be coupled to internet 280. Server 255 broadly represents any computer, data center, virtual machine, or virtual computing instance with or without a hypervisor, or computer executing a containerized program system such as DOCKER or KUBERNETES. Server 255 may represent an electronic digital service that is implemented using more than one computer or instance and that is accessed and used by transmitting web services requests, uniform resource locator (URL) strings with parameters in HTTP payloads, API calls, app services calls, or other service calls. Computer system 205 and server 255 may form elements of a distributed computing system that includes other computers, a processing cluster, server farm or other organization of computers that cooperate to perform tasks or execute applications or services. Server 255 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 255 may comprise a web application server that hosts a presentation layer, application layer and data storage layer such as a relational database system using structured query language (SQL) or no SQL, an object store, a graph database, a flat file system or other data storage.

Computer system 205 can send messages and receive data and instructions, including program code, through the network(s), network link 265 and communication interface 260. In the Internet example, a server 255 might transmit a requested code for an application program through Internet 280, ISP 275, local network 270 and communication interface 260. The received code may be executed by processor 210 as it is received, and/or stored in storage 215, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 210. While each processor 210 or core of the processor executes a single task at a time, computer system 205 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

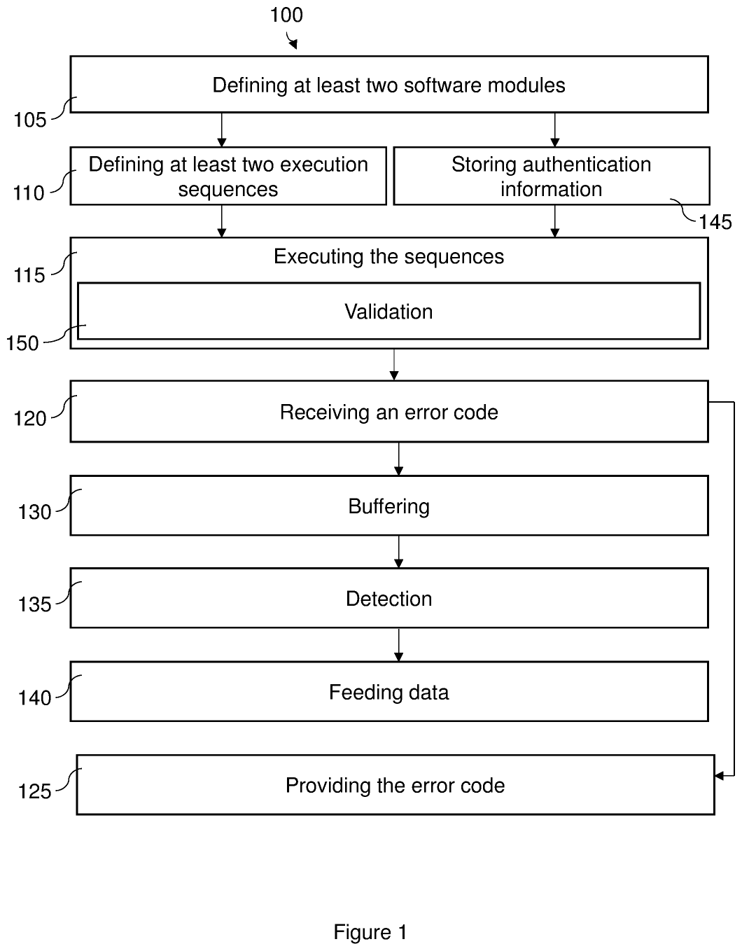

FIG. 1 represents, schematically, a particular succession of steps of the method 100 object of the present invention. This computer-implemented method 100 for software execution automation monitoring, comprises:
a step 105 of defining, upon a computer interface, at least two software modules, each software module being associated with:
   a software digital identifier representative of an existing software to be executed or of an application interface to be addressed,
   an execution error code output format, and
   an execution error code output connector,
a step 110 of defining, upon a computer interface, a sequence of execution of at least two software execution automation processes, each software execution automation process being associated with a sequence of execution of at least one defined software modules,
a step 115 of executing, by a software execution orchestrator ran upon computing device, of the sequence of execution of at least two software execution automation processes by executing the associated sequence of software,
a step 120 of receiving, by the software execution orchestrator, an error code originating from a software module during execution, and
a step 125 of providing, upon a computer interface, an output representative of the received error code and of the software digital identifier associated with the error code originating software module.

The objective of the step 105 of defining is to digitalize a business process relying on several different software of the same or different types in order to automate said business process. During the step 105 of defining, the key modules of the automation process are defined as software modules.

The step 105 of defining is performed, for example, by a computer software executed upon a computing device 205, such as shown in FIG. 2. For example, during this step 105 of defining, instructions stored in the storage 215 and executed by the processor 210 trigger the I/O subsystem 220 to communicate with:
the output device 235, such as a computer screen, in order to show a GUI and
the input 240 device, such as a mouse and keyboard, to collect user input.

During this step 105 of defining, a user may add, edit and/or remove digital representations of software modules, each software module being associated with:
a software digital identifier representative of an existing software to be executed or of an application interface to be addressed,
an execution error code output format, and
an execution error code output connector,

The software digital identifier is, for example, an API address, an executable file or the address to such an executable file.

In particular embodiments, at least one software module is a robotic process automation.

In particular embodiments, at least one software module is an application programing interface.

In particular embodiments, at least one software module is a job scheduling software.

In particular embodiments, at least one software module is a file transfer software.

The execution error code output format is defined by the software, such an error code output format being typically alphanumerical and corresponding, for each value, to a distinct type of error. Such an error may further be associated with a commentary, typically a string of characters providing further details associated with the error code received.

The execution error code output connector is, for example, a software connector, such as an API or any other software output. Such a connector is responsible for transmitting error codes according to the execution error code output format.

For example, the output of the step 105 of is a list of software to be executed in order to complete a business process automation from end-to-end, that is from a standard input to a standard output. The input itself depends on the nature of the first software to be run whereas the output depends on the nature of last software to be run.

It should be understood that software modules can be arranged into a taxonomy wherein software modules may be arranged into levels of dependency between software modules.

The step 110 of defining is performed, for example, by a computer software executed upon a computing device 205, such as shown in FIG. 2. This step 110 of defining may be performed simultaneously to the step 105 of defining software modules, in as such software modules may be defined and sequenced as said software modules are defined. During this step 110 of defining, for example, a user may select, upon a GUI, a defined software module and allocate a number of distinct parameters to said software module, such as:
a preceding software module in the sequence,
a succeeding software module in the sequence,
a run mode of the software module, such as automatic, manual, deferred or orchestrated and/or
an execution authorization value, which can be associated with an authentication information, such as a password or token or any such digital secret allowing for the interfacing of the software module with another software module (both internal and/or external to the defined sequence) or API.

In particular embodiments, such as shown in FIG. 1, at least one software module is further associated with a validation type, said execution type being at least either, manual, deferred, orchestrated or automatic, the step 115 of execution further comprising, if the corresponding software module is associated with a manual validation type, a step 150 of user validation of the execution performed by the software module.

A manual execution type corresponds to a software module requiring user input, via an I/O subsystem 220, to initiate the execution of the software module.

An automatic execution type corresponds to a software module requiring no user input to initiate the execution of the software module.

A deferred, or delayed, execution type corresponds to a software module associated to a date of execution (every night, for example), where the execution of the software module is performed when the date of execution if reached.

An orchestrated execution type corresponds to a software module associated with an increased traceability of the execution, wherein execution logs are provided to a user upon execution of the software module.

The step 150 of user validation may use an I/O subsystem 220 of a computing 205 device. Such an I/O subsystem 220 may be, for example, a GUI shown upon a computer screen allowing a user to visualize the output of a software module and validate, invalidate or edit the output prior to the use of that output by a downstream software module.

The step 115 of executing is performed according to the defined sequence of software modules. The exact nature of the step 115 of executing depends on the nature of the software modules defined during the step 105 of defining software modules. In a particular example of this step 115 of executing:
a first software module receives, as an input, a spreadsheet document comprising names of employees to add to the organization,
a second software module uses the input spreadsheet to connect, for each line corresponding to a new employee to add to a national employment registration office website and, for each detail of the line (age, address, salary for example), fills-in the corresponding field in the website, said software being of the RPA type,
a third software module then uses the input spreadsheet to, via an API, add part of the users to the user base of a third-party customer relation management system, as a function of a job title associated with each line, and
a fourth software module then uses the new inputs to the user base of the third-party customer relation management system to allocate customer identifiers in a third-party sales lead database and update the customer relation management system, such a fourth software module requiring user validation of the attribution of the sales lead.

In particular embodiments, the method 100 object of the present invention comprises a step 145 of storing, by the software execution orchestrator, for at least one software module, authentication information, the step 115 of executing, for said software module, being performed as a function of the stored authentication information.

This authentication information may be any type of digital secret, such a password or certificate for example.

This authentication information may further correspond to a data validation key, defined by a user, which is used to authenticate the data transferred between two software modules or between the software module and the orchestrator.

The step 120 of receiving depends on both the execution error code output format and execution error code output connector of the software module at the source of the error code. In the example mentioned above, a particular error code may correspond to the incapacity to connect to the API of the second software module or the incapacity to allocate a sales lead in the fourth software module to a particular user. The connector can be an API or any other software module output means.

The step 125 of providing may be performed, for example, by using an I/O subsystem 220 of a computing 205 device. Such an I/O subsystem 220 may be, for example, a GUI shown upon a computer screen allowing a user to visualize the software module that is the source of the error code, as well as the error code itself or a representation of said error code, such as a label corresponding to the error code.

In particular embodiments, such as the one shown in FIG. 2, at least one software module is further associated with:
a data input format,
a data input connector,
a data output format,
a data output connector,
   the method further comprising:
a step 130 of buffering data, by the software execution orchestrator, according to a data output format and originating from a data output connector of a software module upstream, in the execution sequence, of a software module from which an error code is originating,
a step 135 of detection, by the software execution orchestrator, of the absence of error code originating from the software module from which an error code was originating, and
a step 140 of feeding data, by the software execution orchestrator, according to a data input format and to a data input connector of the software module from which the absence of error code is detected.

The step 130 of buffering data is performed, for example, by using a memory 225 of the computing system 205. The step 130 of buffering allows the buffering of jobs to be performed by the sequence of remaining software modules that are prone to a particular error.

The step 135 of detection is performed, for example, by a computer software run by a computing system 205. During this step 135 of detection, for example, the absence of an error code is detected when an error code emitting software module stops emitting an error code.

The step 140 of feeding data is performed, for example, by using the data input connector, according to the data input format, of the software module for which an absence of error is detected.

In particular embodiments, such as the one shown in FIG. 1, at least one software module is further associated with a set of instructions, at least one instruction being associated with an instruction digital identifier and an error code, the instruction digital identifier being further received during the step 120 of receiving and this instruction digital identifier being further provided during the step 135 of providing.

A set of instructions may be represented as a schematic succession of steps, such as FIG. 1 is represented, each step corresponding to at least one instruction to be executed by a processor 210 of a computing system 205. Such a set of instructions may correspond to a “no code” programming software, such as Power Automate (trademark registered) by Microsoft (trademark registered). Such instructions may independently be associated with error codes so that, when a software module associated with several instructions emits an error code, that error code can be precisely attached to a particular set of instructions constitutive of that software module.

In particular embodiments, at least one software module or at least one software execution automation process is associated with an execution priority indicator, the step 115 of executing being performed as a function of the execution priority indicator of at least one said software module or software execution automation process.

Such a priority indicator may be manually or automatically set and may correspond to a numerical value that may be compared to other numerical values representative of execution priority in order to determine which software module or software execution automation process to execute first. This is particularly useful in the event where the execution of software execution automation processes has been interrupted due to an error and execution must be resumed in the most optimized manner.

FIG. 2 shows, schematically, a particular representation of the computing system 200 object of the present invention. This computing system 200 for monitoring a software execution automation, comprises:
one or more computer systems 205 comprising one or more hardware processors 210 and storage 215 media; and
instructions stored in the storage media and which, when executed by the computing system, cause the computing system to perform:
   defining, upon a computer interface, at least two software modules, each software module being associated with:
      a software digital identifier representative of an existing software to be executed or of an application interface to be addressed,
      an execution error code output format, and
      an execution error code output connector,
   a step 110 of defining, upon a computer interface, a sequence of execution of at least two software execution automation processes, each software execution automation process being associated with a sequence of execution of at least one defined software modules,
   a step 115 of executing, by a software execution orchestrator ran upon computing device, of the sequence of execution of at least two software execution automation processes by executing the associated sequence of software,
   receiving, by the software execution orchestrator, an error code originating from a software module during execution, and
   providing, upon a computer interface, an output representative of the received error code and of the software digital identifier associated with the error code originating software module.

Particular implementations of the features of this computing system 200 are disclosed in regard to FIG. 1.

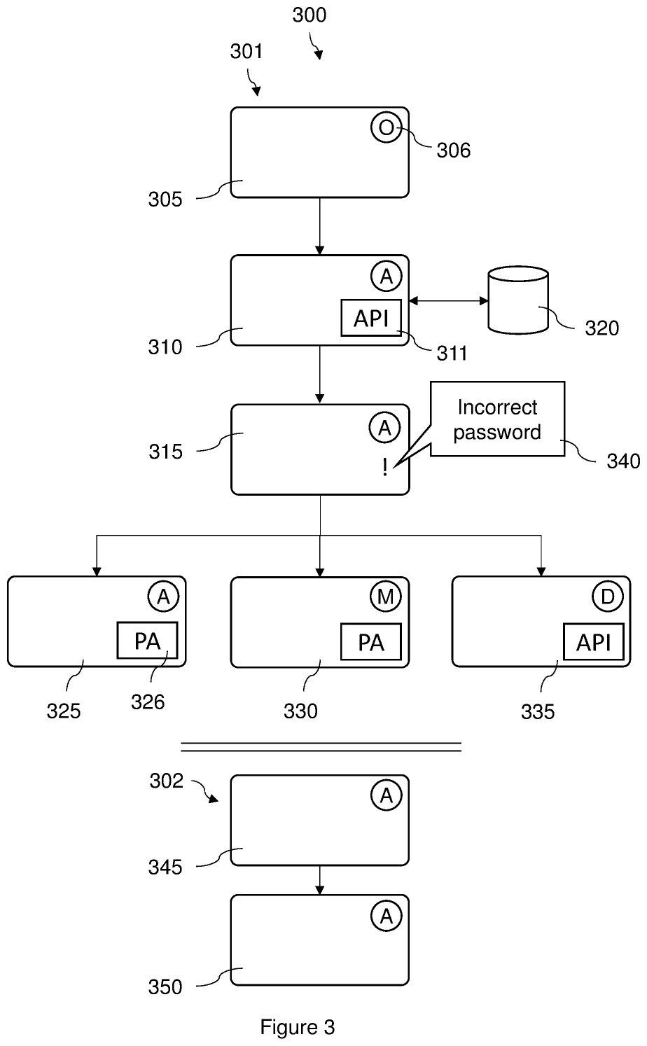

FIG. 3 represents, schematically, a graphical representation of a sequence of software modules corresponding to a succession of business processes, 301 and 302, automation sequence. A first software automation process 301 comprises a succession of software modules, 305, 310 and 315. One of the software modules 315 further comprises three lower-level software modules, 325, 330 and 335. Several software modules, 310, 315, and 325, are automatically executed while one software module 330 requires manual validation of the output or execution, one software module 335 is deferred in execution and one software module 305 is executed by a third-party software. Two software modules, 310 and 335, are associated with an API, such as shown by an indicator 311, while two other software modules, 325 and 300, are associated with a Microsoft Power Automate platform flow of instructions. The type of execution is indicated by an indicator 306. One of the software modules 310 interacts with a database 320 via an API. One of the software modules 315 uses a means of authentication, such as password, to access a resource upon a computing device. In this instance, a software module 315 emits an error code corresponding to an incorrect password blocking the execution of the sequence of software modules.

A second software automation process 302, executed in series or parallel to the first second software automation process 301, comprises two automatically executed software modules, 345 and 350.

### OBJECT OF THE INVENTION

The present invention is intended to remedy all or part of these disadvantages. All embodiments disclosed and claimed herein are directed to a computer-implemented programmed processes that interact with digital data to provide a practical application of computing technology to the problem of software automation monitoring that can be used to increase the reactivity of the information technology department of a company. The disclosure is not intended to encompass techniques for organizing human activity, for performing mental processes, or for performing a mathematical concept, and any interpretation of the claims to encompass such techniques would be unreasonable based upon the disclosure as a whole.

To this effect, according to a first aspect, the present invention aims at a computer-implemented method for software execution automation monitoring, comprising:
a step of defining, upon a computer interface, at least two software modules, each software module being associated with:
   a software digital identifier representative of an existing software to be executed or of an application interface to be addressed,
   an execution error code output format, and
   an execution error code output connector,
a step of defining, upon a computer interface, a sequence of execution of at least two software execution automation processes, each software execution automation process being associated with a sequence of execution of at least one defined software modules,
a step of executing, by a software execution orchestrator ran upon computing device, of the sequence of execution of at least two software execution automation processes by executing the associated sequence of software,
a step of receiving, by the software execution orchestrator, an error code originating from a software module during execution, and
a step of providing, upon a computer interface, an output representative of the received error code and of the software digital identifier associated with the error code originating software module.

Such provisions allows users to monitor software execution error and be notified of the existence of errors as well as the origin of this error within the automated process. The benefits of such provisions are mentioned in the summary of the present invention subsection of this document.

In particular embodiments, at least one software module is further associated with:
a data input format,
a data input connector,
a data output format,
a data output connector,
   the method further comprising:
a step of buffering data, by the software execution orchestrator, according to a data output format and originating from a data output connector of a software module upstream, in the execution sequence, of a software module from which an error code is originating,
a step of detection, by the software execution orchestrator, of the absence of error code originating from the software module from which an error code was originating, and
a step of feeding data, by the software execution orchestrator, according to a data input format and to a data input connector of the software module from which the absence of error code is detected.

Such embodiments allow the process to maintain operational efficiency until the error is resolved, without disrupting the other software components in the process.

In particular embodiments, at least one software module is further associated with a set of instructions, at least one instruction being associated with an instruction digital identifier and an error code, the instruction digital identifier being further received during the step of receiving and this instruction digital identifier being further provided during the step of providing.

Such embodiments allow for the precise determination of the origin of the error code, facilitating maintenance and repairs upon the software module responsible for the process automation failure.

In particular embodiments, the method object of the present invention comprises a step of storing, by the software execution orchestrator, for at least one software module, authentication information, the step of executing, for said software module, being performed as a function of the stored authentication information.

Such embodiments allow for the authentication, on demand, of users implementing the process automation without requiring user input.

In particular embodiments, at least one software module is further associated with a validation type, said execution type being at least either, manual, deferred, orchestrated or automatic, the step of execution further comprising, if the corresponding software module is associated with a manual validation type, a step of user validation of the execution performed by the software module.

Such embodiments allow for the definition of autonomous, semi-autonomous or manual process automation.

In particular embodiments, at least one software module or at least one software execution automation process is associated with an execution priority indicator, the step of executing being performed as a function of the execution priority indicator of at least one said software module or software execution automation process.

Such embodiments allow for the optimized allocation of computing resources from the higher priorities of execution to the lower priorities.

In particular embodiments, at least one software module is a robotic process automation.

In particular embodiments, at least one software module is an application programing interface.

According to a second aspect, the present invention aims at a computing system for monitoring a software execution automation, comprising:
one or more computer systems comprising one or more hardware processors and storage media; and
instructions stored in the storage media and which, when executed by the computing system, cause the computing system to perform:
   defining, upon a computer interface, at least two software modules, each software module being associated with:
      a software digital identifier representative of an existing software to be executed or of an application interface to be addressed,
      an execution error code output format, and
      an execution error code output connector,
   a step of defining, upon a computer interface, a sequence of execution of at least two software execution automation processes, each software execution automation process being associated with a sequence of execution of at least one defined software modules,
   a step of executing, by a software execution orchestrator ran upon computing device, of the sequence of execution of at least two software execution automation processes by executing the associated sequence of software,
   receiving, by the software execution orchestrator, an error code originating from a software module during execution, and
   providing, upon a computer interface, an output representative of the received error code and of the software digital identifier associated with the error code originating software module.

1. Computer-implemented method for software execution automation monitoring, comprising:
a step of defining, upon a computer interface, at least two software modules, each software module being associated with:
a software digital identifier representative of an existing software to be executed or of an application interface to be addressed,
an execution error code output format, and
an execution error code output connector,
a step of defining, upon a computer interface, a sequence of execution of at least two software execution automation processes, each software execution automation process being associated with a sequence of execution of at least one defined software modules,
a step of executing, by a software execution orchestrator ran upon computing device, of the sequence of execution of at least two software execution automation processes by executing the associated sequence of software,
a step of receiving, by the software execution orchestrator, an error code originating from a software module during execution, and
a step of providing, upon a computer interface, an output representative of the received error code and of the software digital identifier associated with the error code originating software module.

2. Method according to claim 1, in which at least one software module is further associated with:
a data input format,
a data input connector,
a data output format,
a data output connector,
the method further comprising:
a step of buffering data, by the software execution orchestrator, according to a data output format and originating from a data output connector of a software module upstream, in the execution sequence, of a software module from which an error code is originating,
a step of detection, by the software execution orchestrator, of the absence of error code originating from the software module from which an error code was originating, and
a step of feeding data, by the software execution orchestrator, according to a data input format and to a data input connector of the software module from which the absence of error code is detected.

3. Method according to claim 1, in which at least one software module is further associated with a set of instructions, at least one instruction being associated with an instruction digital identifier and an error code, the instruction digital identifier being further received during the step of receiving and this instruction digital identifier being further provided during the step of providing.

4. Method according to claim 1, which comprises a step of storing, by the software execution orchestrator, for at least one software module, authentication information, the step of executing, for said software module, being performed as a function of the stored authentication information.

5. Method according to claim 1, in which at least one software module is further associated with a validation type, said execution type being at least either, manual, deferred, orchestrated or automatic, the step of execution further comprising, if the corresponding software module is associated with a manual validation type, a step of user validation of the execution performed by the software module.

6. Method according to claim 1, in which at least one software module or at least one software execution automation process is associated with an execution priority indicator, the step of executing being performed as a function of the execution priority indicator of at least one said software module or software execution automation process.

7. Method according to claim 1, in which at least one software module is a robotic process automation software.

8. Method according to claim 1, in which at least one software module is an application programing interface.

9. A computing system for monitoring a software execution automation, comprising:
one or more computer systems comprising one or more hardware processors and storage media; and
instructions stored in the storage media and which, when executed by the computing system, cause the computing system to perform:
defining, upon a computer interface, at least two software modules, each software module being associated with:
a software digital identifier representative of an existing software to be executed or of an application interface to be addressed,
an execution error code output format, and
an execution error code output connector,
a step of defining, upon a computer interface, a sequence of execution of at least two software execution automation processes, each software execution automation process being associated with a sequence of execution of at least one defined software modules,
a step of executing, by a software execution orchestrator ran upon computing device, of the sequence of execution of at least two software execution automation processes by executing the associated sequence of software,
receiving, by the software execution orchestrator, an error code originating from a software module during execution, and
providing, upon a computer interface, an output representative of the received error code and of the software digital identifier associated with the error code originating software module.
